(19) United States
(12) Patent Application Publication
(10) Pub. No.: US 2011/0013094 A1
(43) Pub. Date: Jan. 20, 2011

(54) LAMP MOUNT, LIGHTING DEVICE, DISPLAY DEVICE AND TELEVISION RECEIVER

(75) Inventor: Mitsuhiro Moriyasu, Osaka-shi (JP)

Correspondence Address: SHARP KABUSHIKI KAISHA;C/O KEATING & BENNETT, LLP, 1800 Alexander Bell Drive, SUITE 200, Reston, VA, 20191, US

(73) Assignee: SHARP KABUSHIKI KAISHA, Osaka-shi, Osaka (JP)

(21) Appl. No.: 12/919,273

(22) PCT Filed: Feb. 26, 2009
(86) PCT No.: PCT/JP2009/053531

§ 371 Date: Aug. 25, 2010

(30) Foreign Application Priority Data
Feb. 27, 2008 (JP) 2008-046716

(51) Int. Cl. H04N 5/66; F21V 21/00; G02F 1/13357; G02F 1/1333

(52) U.S. Cl. 348/739; 362/217.14; 362/217.16; 362/97.1; 349/58; 348/E05.133

(57) ABSTRACT

A lamp mount 19 of the present invention is configured to mount a tubular lamp 17 having a curved outer surface to a mounting member 14. The lamp mount includes an insertion hole 54 for receiving an end of the tubular lamp 17. The insertion hole 54 has a bottom surface 54a located closer to the mounting member 14 and a ceiling surface 54b opposed to the bottom surface. Each of the bottom surface 54a and the ceiling surface 54b is in contact with the tubular lamp 17 on a line perpendicular to a surface on which the mounting member 14 is mounted and has at least flat surface portion.

### TECHNICAL FIELD

The present invention relates to a lamp mount, a lighting device, a display device and a television receiver.

### BACKGROUND ART

A liquid crystal panel included in a liquid crystal display device such as a liquid crystal television does not emit light, and thus a backlight device is required as a separate lighting device. The backlight device is arranged behind the liquid crystal panel (i.e., on a side opposite from a display surface side). It includes a metal chassis having an opening on a liquid crystal panel side, a plurality of linear light sources (e.g., cold cathode tubes) and a lamp holder that supports and fixes the linear light sources to the chassis at the two ends of each linear light source.

A cold cathode tube selected as the linear light source is generally configured such that an inner wall of a glass tube is coated with a fluorescent material and inert gas (such as argon) and mercury are sealed in the glass tube. High voltage is generated between two electrodes each of which is arranged at each end of the glass tube to start discharge. Vaporized mercury is excited due to its collision with electrons or atoms of the sealed gas to generate ultraviolet rays. The ultraviolet rays excite the fluorescent material coated on the inner wall of the glass tube and visible light represented by white light is emitted.

The two ends of the cold cathode tube are connected to a lamp holder. Generally, each of the ends of the cold cathode tube is inserted in an opening provided in the lamp holder. If the cold cathode tube is lit, temperature of the cold cathode tube is increased and heat is radiated from the ends to the lamp holder. If the lamp holder is tightly adhered to the ends of the cold cathode tube so as to surround entire peripheral surfaces of the ends, the radiation amount from the cold cathode tube is increased and the temperature of the ends becomes comparatively low. Accordingly, mercury sealed in the glass tube is concentrated at the ends whose temperature is comparatively low due to the temperature-dependent properties of mercury. This causes a nonuniform distribution of mercury vapor in the glass tube. That is, the concentration of mercury vapor is high at the ends of the glass tube and low at a center thereof. As a result, the concentration of mercury vapor is comparatively low at the center of the cold cathode tube in its longitudinal direction, and therefore the light emission amount is reduced there. Therefore, the light emission amount is varied area to area in the cold cathode tube and this may cause brightness nonuniformity of the backlight device. Therefore, the contact area between the cold cathode tube and the lamp holder is preferably set to a minimum that is required by the lamp holder to support the cold cathode tube. An example of such a lamp holder is disclosed in Patent Document 1.

The lamp holder disclosed in Patent Document 1 has an insertion hole where a plurality of grooves are formed such that an outer surface of the linear light source comes in contact with lower ends of the grooves with point contact. Each end of the linear light source is inserted in the insertion hole. This reduces a contact area between the linear light source and the lamp holder and therefore the heat radiation from the cold cathode tube is suppressed.

[Patent Document] Japanese Unexamined Patent Publication No. 2002-100233

### Problem to be Solved by the Invention

It has been required to make the liquid crystal display device thinner, and to make the liquid crystal display device thinner, it is preferable that the lamp holder that is a component of the liquid crystal display has the smallest possible height. However, the lamp holder disclosed in Patent Document 1 is configured to have a plurality of grooves in the surface of the insertion hole, that is, to have portions that are projected from the inner surface of the insertion hole. Therefore, the lamp holder is required to have a thickness in its height direction including at least a diameter of the linear light source, a thickness of the grooves (a height of the projected portions in the insertion hole) and a thickness for ensuring strength of the lamp holder. Therefore, it is difficult to make a further reduction in the height of the lamp holder.

### DISCLOSURE OF THE PRESENT INVENTION

The present invention was made in view of the foregoing circumstances. An object of the present invention is to provide a lamp mount that enables its thickness reduction and has a configuration in that a contact area between the lamp mount and a tubular lamp is small to suppress nonuniformity of light emission from the tubular lamp. Another object of the present invention is to provide a lighting device including such a lamp mount, a display device including such a lighting device, and a television receiver including such a display device.

### Means for Solving the Problem

To solve the above problem, a lamp mount for mounting a tubular lamp having a curved outer surface to a mounting member includes an insertion hole for receiving an end of the tubular lamp. The insertion hole has a bottom surface located closer to the mounting member and a ceiling surface opposed to the bottom surface. Each of the bottom surface and the ceiling surface is to be in contact with the tubular lamp on a line perpendicular to a surface of the mounting member on which the lamp mount is to be mounted and has at least a flat surface portion.

According to the configuration of the present invention, the bottom surface and the ceiling surface of the insertion hole are in contact with the tubular lamp on a line perpendicular to the surface of the mounting member on which the lamp mount is mounted. The direction of the line perpendicular to the surface of the mounting member on which the lamp mount is mounted corresponds to a height direction of the lamp mount from the mounting member. Therefore, in the above configuration, any space or component is not provided between a wall of the insertion hole and the tubular lamp in the height direction of the lamp mount. Accordingly, the height of the lamp mount is defined by only a total of a diameter of the tubular lamp (a height of the insertion hole) and a thickness required to ensure the strength of the lamp mount. Namely, the height of the lamp mount can be reduced as much as possible. The lamp mount having the above configuration is effective in reducing the thickness of the lighting device provided with a tubular lamp, for example.

Further, since each of the bottom surface and the ceiling surface of the insertion hole has a flat surface portion, the outer curved surface (outer peripheral surface) of the tubular lamp is in contact with the flat surface of the insertion hole with point contact. In such a case, a contact area between the tubular lamp and a surface of the insertion hole is able to become relatively small.

If the insertion hole is configured such that surfaces of the insertion hole are adhered to and surround an entire outer peripheral surface of the end of the tubular lamp, the contact area between the tubular lamp and the surface of the insertion hole becomes large. This increases the amount of the heat radiation from the tubular lamp and the temperature of the end becomes relatively low. If a cold cathode tube is used as the tubular lamp, mercury sealed in the cold cathode tube moves to and is concentrated at the end sides where the temperature is relatively low in the cold cathode tube according to the temperature-dependent properties of mercury. This causes a nonuniform concentration distribution of mercury vapor in the cold cathode tube wherein the concentration of mercury vapor is high at the ends of the cold cathode tube and low at the center. As a result, since the concentration of mercury vapor is comparatively low at the center of the cold cathode tube in its longitudinal direction, the light emission amount is reduced. This may cause nonuniformity of the light emission amount from the cold cathode tube.

However, according to the configuration of the present invention, each of the bottom surface and the ceiling surface that are in contact with the tubular lamp, respectively, has a flat surface portion. On the flat surface portion, the outer peripheral surface of the tubular lamp is to be in contact with the flat surface of the insertion hole with point contact. This enables the contact area between the tubular lamp and the surface of the insertion hole to be relatively small. Accordingly, the amount of the radiation from the tubular lamp to the lamp mount is suppressed to be relatively small. Therefore, for example, the nonuniform concentration of mercury vapor that may be caused in the cold cathode tube is suppressed and nonuniformity of the light emission from the cold cathode tube is suppressed.

### BRIEF DESCRIPTION OF THE DRAWINGS

FIG. 1 is an exploded perspective view illustrating a general construction of a television receiver according to a first embodiment of the present invention;

FIG. 2 is an exploded perspective view illustrating a general construction of a liquid crystal display device provided in the television receiver;

FIG. 3 is a cross-sectional view illustrating a cross-sectional configuration of the liquid crystal display device along the short-side direction;

FIG. 4 is a cross-sectional view illustrating a cross-sectional configuration of the liquid crystal display device along the long-side direction;

FIG. 5 is a cross-sectional view illustrating a configuration of a cold cathode tube provided in the liquid crystal display device;

FIG. 6 is a perspective view illustrating a configuration of a lamp connector provided in the liquid crystal display device;

FIG. 7 is an axial cross-sectional view illustrating a state in that the cold cathode tube is mounted to the lamp connector;

FIG. 8 is a vertical cross-sectional view with respect to an axial line of the cold cathode tube illustrating a state in that the cold cathode tube is mounted to the lamp connector;

FIG. 9 is an axial cross-sectional view illustrating a general construction of a lamp connector according to a second embodiment of the present invention;

FIG. 10 is a cross-sectional view illustrating the lamp connector taken along an A-A line in FIG. 9;

FIG. 11 is a cross-sectional view illustrating the lamp connector taken along a B-B line in FIG. 9;

FIG. 12 is a cross-sectional view illustrating a lamp connector of one modified example;

FIG. 13 is a cross-sectional view illustrating a lamp connector of another modified example; and

FIG. 14 is an axial cross-sectional view illustrating a lamp connector of additional modified example.

### BEST MODE FOR CARRYING OUT THE INVENTION

### First Embodiment

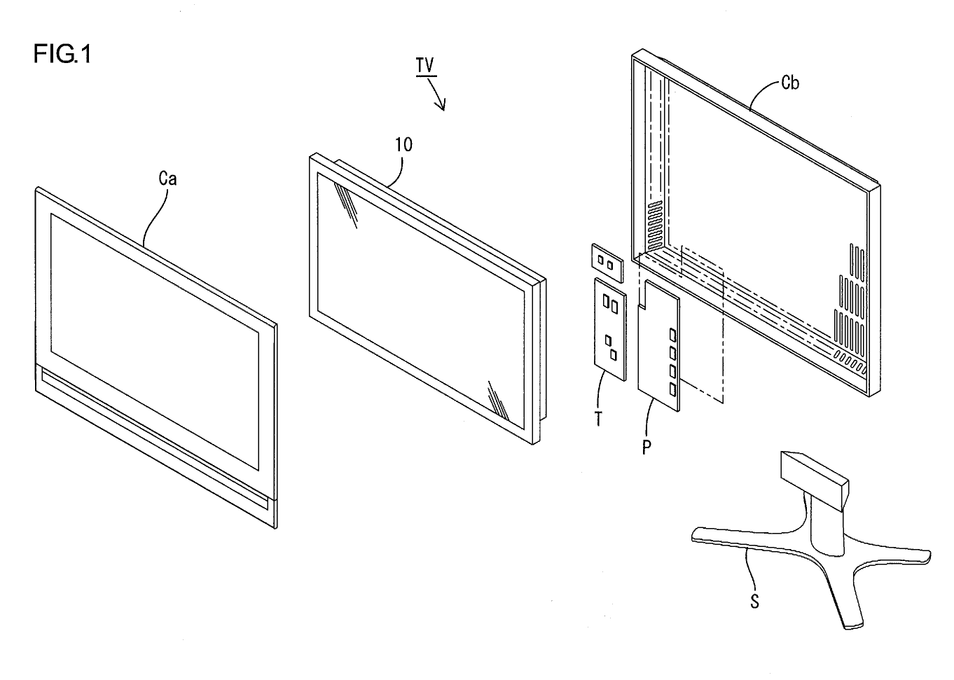

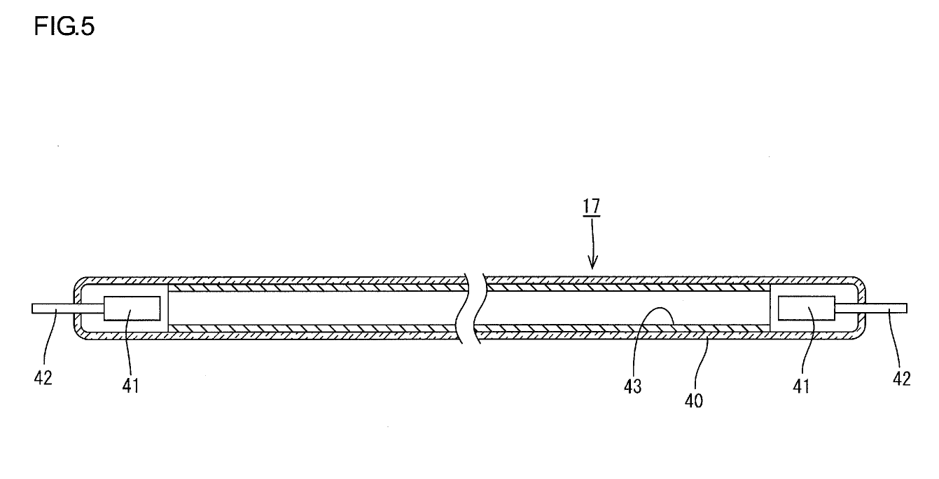

The first embodiment of the present invention will be explained with reference to FIGS. 1 to 8. A television receiver TV including a liquid crystal display device 10 will be explained with reference to FIGS. 1 to 4.

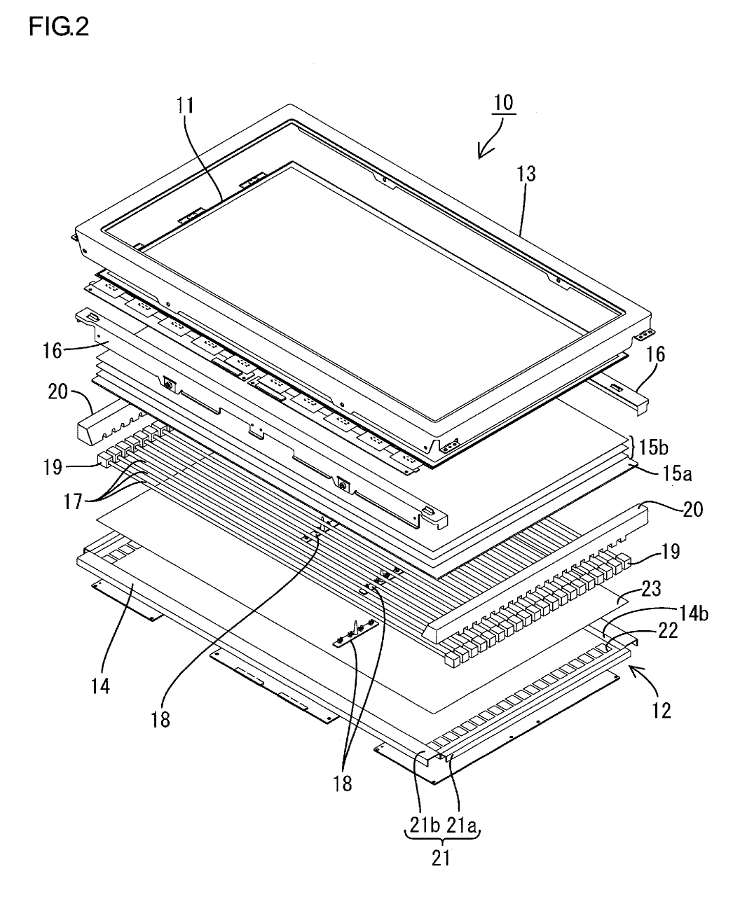

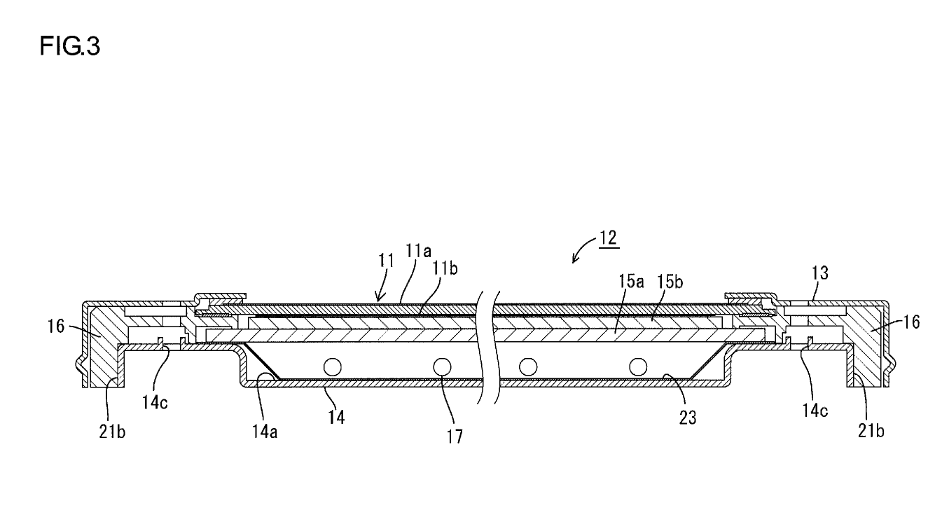

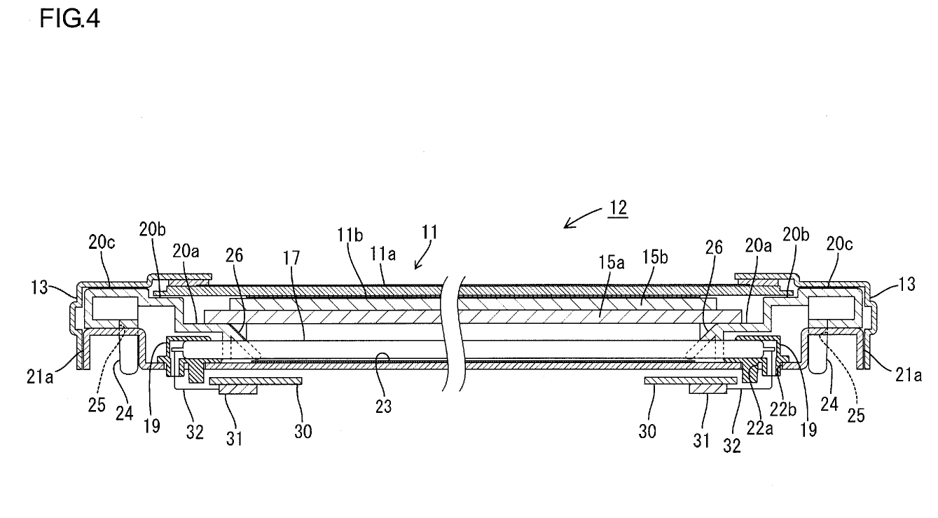

FIG. 1 is an exploded perspective view illustrating a general construction of the television receiver according to the first embodiment. FIG. 2 is an exploded perspective view illustrating a general construction of the liquid crystal display device provided in the television receiver shown in FIG. 1. FIG. 3 is a cross-sectional view illustrating a cross-sectional configuration of the liquid crystal display device in FIG. 2 along the short-side direction. FIG. 4 is a cross-sectional view illustrating a cross-sectional configuration of the liquid crystal display device in FIG. 2 along the long-side direction.

As illustrated in FIG. 1, the television receiver TV of the present embodiment includes the liquid crystal display device 10, front and rear cabinets Ca, Cb that house the liquid crystal display device 10 therebetween, a power source P, a tuner T and a stand S. An overall shape of the liquid crystal display device (display device) 10 is a landscape rectangular. The liquid crystal display device 10 is housed in a vertical position. As illustrated in FIG. 2, it includes a liquid crystal panel 11 as a display panel, and a backlight device 12 (lighting device), which is an external light source. They are integrally held by a bezel 13 having a frame shape and the like.

Next, the liquid crystal panel 11 and the backlight device 12 included in the liquid crystal display device 10 will be explained (see FIGS. 2 to 4).

The liquid crystal panel (display panel) 11 is constructed such that a pair of glass substrates is bonded together with a predetermined gap therebetween and liquid crystal is sealed between the glass substrates. On one of the glass substrates, switching components (e.g., TFTs) connected to source lines and gate lines that are perpendicular to each other, pixel electrodes connected to the switching components, and an alignment film are provided. On the other substrate, a color filter having color sections such as R (red), G (green) and B (blue) color sections arranged in a predetermined pattern, counter electrodes, and an alignment film are provided. Polarizing plates 11a, 11b are attached to outer surfaces of the substrates (see FIGS. 3 and 4).

As illustrated in FIG. 2, the backlight device 12 includes a chassis 14, a diffuser plate 15a, a plurality of optical sheets 15b and frames 16. The chassis 14 has a substantially box-shape and an opening 14b on the light emitting side (on the liquid crystal panel 11 side). The diffuser plate 15a are arranged so as to cover the opening 14b of the chassis 14. The optical sheets 15b are arranged between the diffuser plate 15a and the liquid crystal panel 11. The frames 16 arranged along the long sides of the chassis 14 hold the long-side edges of the diffuser plate 15a to the chassis 14. The long-side edges of the diffuser plate 15a are sandwiched between the chassis 14 and the frames 16. Cold cathode tubes (light sources) 17, lamp clips 18, lamp connectors (lamp mount) 19 and lamp holders 20 are installed in the chassis 14. The lamp clips 18 hold the cold cathode tubes 17 to support them at a predetermined height position. The lamp connectors 19 hold each end of the cold cathode tubes 17 to be mounted to the chassis 14. The lamp holders 20 collectively cover the ends of the cold cathode tubes 17 and the lamp connectors 19. A light emitting side of the backlight device 12 is a side closer to the diffuser plate 15a than the cold cathode tubes 17.

The chassis 14 is made of metal. It is formed in a substantially shallow box shape with metal plating. It includes a rectangular bottom plate 14a and outer rims 21 (short-side outer rims 21a and long-side outer rims 21b), each of which extends upright from the corresponding side of the bottom plate 14a and has a substantially U shape. The bottom plate 14a of the chassis 14 has a plurality of stopper holes 22a and insertion holes 22b at two ends of the bottom plate 14a in the long-side edges thereof. The lamp connectors 19 are mounted in the stopper holes 22a and the insertion holes 22b. As illustrated in FIG. 3, fixing holes 14c are provided in the upper surface of the chassis 14 along the long-side outer rims 21b to bind the bezel 13, the frames 16 and the chassis 14 together with screws and the like.

Alight reflecting sheet 23 is disposed on an inner surface of the bottom plate 14a of the chassis 14 (on a side that faces the cold cathode tubes 17). The light reflecting sheet 23 is a synthetic resin sheet having a surface in white color that provides high light reflectivity. It is placed so as to cover almost entire inner surface of the bottom plate 14a of the chassis 14. As illustrated in FIG. 3, long-side edges of the light reflecting sheet 23 are lifted so as to cover the long-side outer rims 21b of the chassis 14 and sandwiched between the chassis 14 and the diffuser plate 15a. With this light reflecting sheet 23, light emitted from the cold cathode tubes 17 is reflected toward the diffuser plate 15a.

An inverter board set 30 is provided on an outer surface of the bottom plate 14a of the chassis 14 (on the side opposite from the side where the cold cathode tubes 17 are provided) as illustrated in FIG. 4. The inverter board set 30 supplies power to the cold cathode tubes 17. A circuit for supplying power to the cold cathode tubes 17 (not shown) is formed on the inverter board set 30. Aboard connector 31 that is connected to the circuit is mounted to an outer edge of the inverter board set 30 (an edge closer to the end of the chassis 14 in the long-side direction). A harness 32 supplying driving power extends from the board connector 31 and is connected to the cold cathode tubes 17 in the lamp connector 19. The lamp connector 19 functions as a relay point that establishes an electrical connected state between the inverter board set 30 and the cold cathode tubes 17.

On the opening 14b side of the chassis 14, the diffuser plate 15a and the optical sheets 15b are provided. The diffuser plate 15a includes a synthetic resin plate containing scattered light diffusing particles. It diffuses linear light emitted from the cold cathode tubes 17 that is a tubular light source. The short-side edges of the diffuser plate 15a are placed on the first surface 20a of the holder 20 as described above, and does not receive a vertical force. As illustrated in FIG. 3, the long-side edges of the diffuser plate 15a are sandwiched between the chassis 14 (the reflecting sheet 23) and the frame 16 and fixed.

The optical sheets 15b provided on the diffuser plate 15a include a diffuser sheet, a lens sheet and a reflecting type polarizing plate layered in this order from the diffuser plate 15a side. Light emitted from the cold cathode tubes 17 passes through the diffuser plate 15a and enters the optical sheets 15b. The optical sheets 15b convert the light to planar light. The liquid crystal display panel 11 is disposed on the top surface of the top layer of the optical sheets 15b. The optical sheets 15b are held between the diffuser plate 15a and the liquid crystal panel 11.

Each cold cathode tube 17 has an elongated tubular shape. A plurality of the cold cathode tubes 17 are installed in the chassis 14 such that they are arranged parallel to each other with the long-side direction thereof (the axial direction) aligned along the long-side direction of the chassis 14 (see FIGS. 2 and 4). Each cold cathode tube 17 comprises an elongated glass tube 40, electrodes 41 and outer leads 42. Two ends of the glass tube 40 are closed. The electrodes 41 are enclosed at two ends of the glass tube 40. Each outer lead 32 extends from the corresponding electrode 41 to the outside of the glass tube 40. Noble gas and mercury are enclosed in the glass tube 40 and the inner surface of the glass tube 40 is coated with a fluorescent material 43. Portions at two ends of each cold cathode tube 17 provided with the electrodes 41 correspond to non-light-emitting portions and a center portion of each cold cathode tube 17 (that is coated with the fluorescent material 43) corresponds to a light-emitting portion. Each cold cathode tube 17 is held by a lamp clip 18 (not shown in FIGS. 3 and 4) so as to be supported to have a small distance between the bottom plate 14a (reflecting sheet 23) of the chassis 14 and the cold cathode tube 17. Each end of each cold cathode tube 17 is fitted in the corresponding lamp connector 19. The holders 20 are mounted so as to cover the lamp connectors 19.

The diameter of each cold cathode tube 17 used in this embodiment is 4.0 mm. The distance between the cold cathode tubes 17 and the reflecting sheet 23 is 0.8 mm. The distance between the adjacent cold cathode tubes 17 is 16.4 mm. The distance between the cold cathode tubes 17 and the diffuser plate 15a is 2.7 mm. In this backlight device 12, distances between the components are defined so as to reduce the thickness of the backlight device 12. Especially, the distance between the cold cathode tubes 17 and the diffuser plate 15a and the distance between the cold cathode tubes 17 and the reflecting sheet 23 are reduced. Because of the thickness reduction of the lighting device 12, the liquid crystal display device 10 and that of the television receiver TV are provided with the following thickness. The thickness of the liquid crystal display device 10 (i.e., the thickness between the front surface of the liquid crystal panel 11 and the back surface of the backlight device 12) is 16 mm. The thickness of the television receiver TV (i.e., the thickness between the front surface of the front cabinet Ca and the back surface of the rear cabinet Cb) is 34 mm. Namely, a thin television receiver is provided.

The holders 20 that cover the ends of the cold cathode tubes 17 are made of white synthetic resin. As illustrated in FIG. 2, each of them has an elongated substantially box shape that extends along the short side of the chassis 14. As illustrated in FIG. 4, each holder 20 has steps on the front side such that the diffuser plate 15a and the liquid crystal panel 11 are held at different levels. A part of the holder 20 is placed on top of a part of the corresponding short-side folded outer rim 21a of the chassis 14 and forms a side wall of the backlight device 12 together with the folded outer rim 21a. An insertion pin 24 projects from a surface of the holder 20 that faces the folded outer rim 21a of the chassis 14. The holder 20 is mounted to the chassis 14 by inserting the insertion pin 24 into the insertion hole 25 provided in the top surface of the folded outer rim 21a of the chassis 14.

The steps of the holder 20 include three surfaces parallel to the bottom plate 14a of the chassis 14. The short edge of the diffuser plate 15a is placed on the first surface 20a located at the lowest level. A sloped cover 26 extends from the first surface 20a toward the bottom plate 14a of the chassis 14. A short edge of the liquid crystal panel 11 is placed on the second surface 20b of the steps of the holder 20. The third surface 20c located at the highest level of the steps of the holder 20 is provided such that it overlaps the folded outer rim 21a of the chassis 14 and comes in contact with the bezel 13.

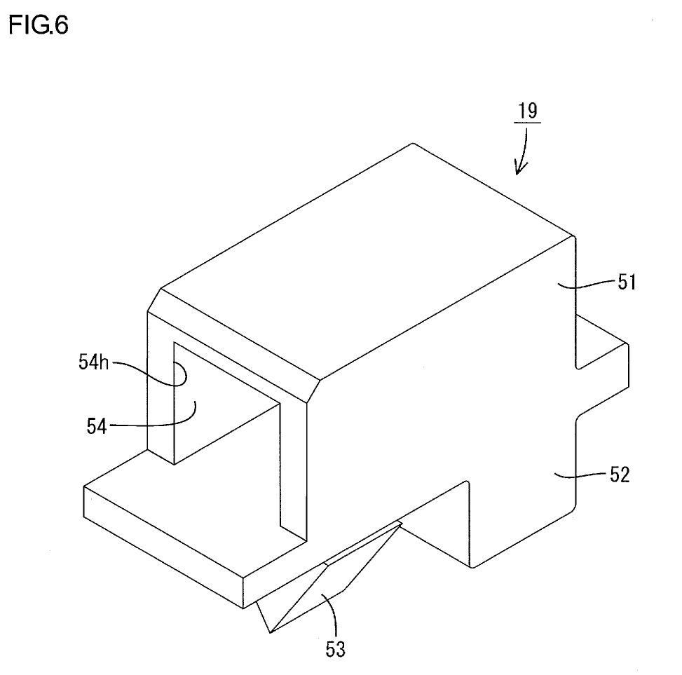

The lamp connector 19 that holds the end of each cold cathode tube 17 to mount the cold cathode tube 17 to the chassis 14 will be explained in details with reference to FIGS. 6 to 8.

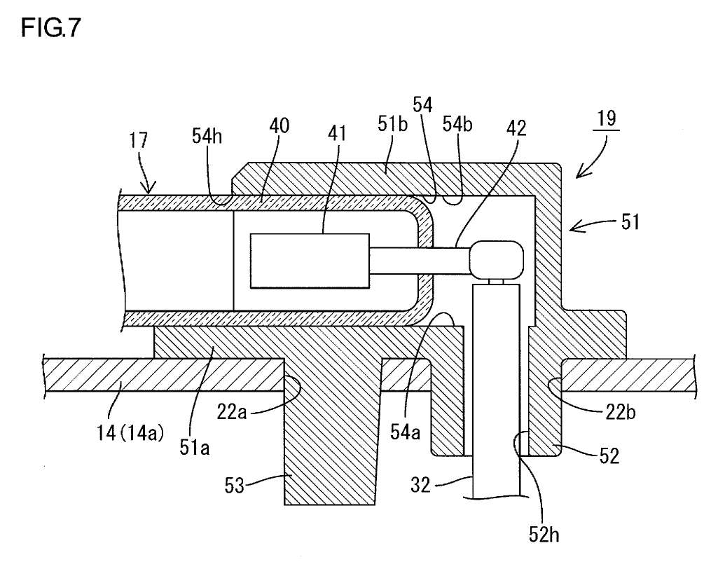

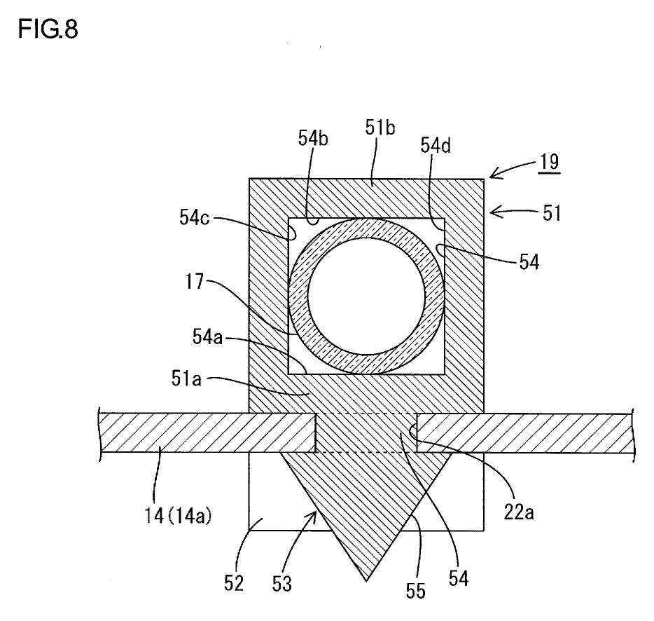

FIG. 6 is a perspective view illustrating a general construction of the lamp connector. FIG. 7 is an axial cross-sectional view illustrating a state in that the cold cathode tube is mounted to the lamp connector. FIG. 8 is a vertical cross-sectional view with respect to the axial line illustrating a state in that the cold cathode tube is mounted to the lamp connector.

As described above, the lamp connector 19 holds each end of the cold cathode tube 17 to mount the cold cathode tube 17 to the chassis 14. The lamp connector 19 is formed of nonconductive rubber with molding to prevent leakage from the cold cathode tubes 17. The lamp connector 19 comprises a main body 51, an introduction portion 52 and a stopper 53, as illustrated in FIGS. 6 to 8. An overall shape of the main body 51 is a substantially quadrangular prism. The harness 32 extending from the inverter board set 30 is introduced to the introduction portion 52. The stopper 53 is engaged to the stopper hole 22a formed in the chassis 14. The main body 51 is a portion provided on an inner surface of the bottom plate 14a of the chassis 14 (a surface where the cold cathode tubes 17 are provided), and the introduction portion 52 and the stopper 53 penetrate through the bottom plate 14a to be exposed from an outer surface of the bottom plate 14a (a surface where the inverter board set 30 is provided).

The main body 51 is formed in a substantially landscape quadrangular prism. The main body 51 is provided on an inner surface of the chassis 14 such that its longitudinal direction (axial direction) is aligned along a long-side direction of the chassis 14. As illustrated in FIGS. 7 and 8, an insertion hole 54 having an insertion opening (opening) 54h is formed in a center of a surface of the main body 51 closer to the cold cathode tubes 17. The end of the cold cathode tube 17 is inserted to the insertion hole 54 to connect the cold cathode tube 17 and the lamp connector 19.

The insertion hole 54 is formed in a quadrangular prism extending from the insertion opening 54h along an axial direction of the main body 51. The insertion hole 54 is not penetrated to a surface of the main body 51 opposite from the one having the insertion opening 54h (see FIG. 7). A vertical cross section of the lamp connector 19 perpendicular to an axial line of the insertion hole 54 (a cross section of the lamp connector 19 in the up-and-down direction) includes a square (a polygonal, a quadrangle) hole section of the insertion hole 54 as same as that of the insertion opening 54h, as illustrated in FIG. 8. In other words, a bottom surface 54a of the insertion hole 54 located closer to the chassis 14, a ceiling surface 54b opposed to the bottom surface 54a, and side surfaces 54c, 54d each connecting the long sides are formed in flat surfaces. The insertion hole 54 is defined by the four flat surfaces 54a, 54b, 54c, 54d and extends from the insertion opening 54h through which the cold cathode tube 17 is inserted to an end-side portion where an end of the cold cathode tube 17 reaches. A length of each short side of the bottom surface 54a, the ceiling surface 54b and the side surfaces 54c, 54d (a side of the insertion hole 54 in the vertical cross section of the lamp connector 19 perpendicular to the axial line of the insertion hole 54, a side of the insertion opening 54h) is 4.0 mm and is same as a diameter (an outer diameter) of the cold cathode tube 17. Therefore, when the cold cathode tube 17 is inserted in the insertion hole 54, the bottom surface 54a, the ceiling surface 54b and the side surfaces 54c, 54d are brought into contact with the cold cathode tube 17, as illustrated in FIG. 7. Each surface 54a, 54b, 54c, 54d of the insertion hole 54 is formed in a flat surface. However, a vertical cross section of the cold cathode tube 17 is a circle. Therefore, the surface of the insertion hole 54 is in point contact with the cold cathode tube 17 (see FIG. 8).

Peripheral portions (walls) of the insertion hole 54 formed in the main body 51 are plates each having a uniform thickness. A length of a bottom plate (a lower wall) 51a opposed to the chassis 14 in an axial direction of the main body 51 is longer than a length of a top plate (an upper wall) 51b located at an opposite side from the bottom plate 51a, as illustrated in FIG. 7. Therefore, the lamp connector 19 is wider at a side closer to the bottom plate 14a of the chassis 14 (a bottom plate 51a side of the main body 51). This ensures attachment stability.

The bottom plate 51a of the main body 51 has an inner surface (the bottom surface 54a of the insertion hole 54) and an outer surface (a surface opposed to the bottom plate 14a of the chassis 14) that are flat surfaces substantially parallel to the bottom plate 14a of the chassis 14. The bottom plate 51a is a plate having a thickness of 1.0 mm in this embodiment. The top plate 51b of the main body 51 has an inner surface (the ceiling surface 54b of the insertion hole 54) and an outer surface (an upper end surface of the lamp connector 19) that are flat surfaces substantially parallel to the bottom plate 14a of the chassis 14. The top plate 51b is a plate having a thickness of 1.0 mm in this embodiment. Therefore, a height of the lamp connector 19 that is mounted to the chassis 14 (a height from the outer surface of the bottom plate 51a of the main body 51 to the outer surface of the top plate 51b) is 6.0 mm that is a total of the thickness of the bottom plate 51a and the thickness of the top plate 51b of the main body 51 and the length of one side of the insertion hole 54 (a distance between the bottom surface 54a and the ceiling surface 54b that are opposed to and parallel to each other). The thickness of the bottom plate 51a and the top plate 51b is 1.0 mm in this embodiment. However, it can be set to be any value with considering strength and workability of the main body 51 (the bottom plate 51a and the top plate 51b) or prevention of leakage from the cold cathode tubes 17.

The introduction portion 52 and the stopper 53 are projected from the outer surface of the bottom plate 51a of the main body 51 (a surface of the main body 51 opposed to the bottom plate 14a of the chassis 14). The introduction portion 52 extends from the end of the main body 51 that is opposite from the side where the cold cathode tube 17 is mounted toward the bottom plate 14a side. The introduction portion 52 is exposed from the outer surface of the bottom plate 14a (the surface opposed to the one where the main body 51 is provided) through the insertion hole 22b provided in the bottom plate 14a of the chassis 14. An introduction path 52h having a circular cross section is formed in the introduction portion 52. The harness 32 extending from the board connector 31 is introduced to (inserted through) the introduction path 52h. The introduction path 52h extends in the up-and-down direction of the lamp connector 19. A lower end of the introduction path 52h is open at the lower end of the introduction portion 52 and an upper end of the introduction path 52h is communicated with the end-side portion in the insertion hole 54. The harness 32 extending from the board connector 31 is introduced from the lower end to the upper end in the introduction path 52h and connected to a distal end of the outer lead 42 extended from the end of the cold cathode tube 17. The harness 32 establishes an electrical connected state between the inverter board set 30 and the cold cathode tube 17.

The stopper 53 is a plate that extends from a substantially center of the main body 51 in its axial line toward the bottom plate 14a of the chassis 14. The stopper 53 includes a shaft portion 54 and a stopper piece 55. The shaft portion 54 extends from the bottom plate 51a of the main body 51 and has a quadrangular cross section. The stopper piece 55 is provided at the distal end of the shaft portion 54 and has a triangular cross section. The stopper 53 is exposed from the outer surface of the bottom plate 14a of the chassis 14 (a surface opposite from the one where the main body 51 is provided) via the stopper hole 22a formed in the bottom plate 14a of the chassis 14. The width of the shaft portion 54 of the stopper 53 is equal to or slightly smaller than the width of the stopper hole 22a, and the width of the stopper piece 55 (a length of one side of the triangular cross section) is greater than the width of the stopper hole 22a. Therefore, the stopper piece 55 passes through the stopper hole 22a with being elastically deformed and thereafter elastically restores its original shape. Accordingly, the width of the stopper piece 55 is greater than the width of the stopper hole 22a. The length of the shaft portion 54 of the stopper 53 is substantially equal to the thickness of the bottom plate 14a of the chassis 14. When the stopper 53 is inserted in the stopper hole 22a, the upper surface of the stopper piece 55 provided at the distal end of the shaft portion 54 (the surface opposed to the bottom plate 14a of the chassis 14) is contacted to the outer surface of the bottom plate 14a and the stopper 53 is engaged to the bottom plate 14a. With such mounting means, the lamp connectors 19 are mounted to the end of the chassis 14 in the long-side direction so as to be aligned along an alignment direction of the cold cathode tubes 17.

As is explained above, according to the present embodiment, the lamp connector 19 has the insertion hole 54 where the end of the cold cathode tube 17 is inserted. The insertion hole 54 comprises the bottom surface 54a that is in contact with the cold cathode tube 17 on a line perpendicular to the bottom plate 14a of the chassis and the ceiling surface 54b that is opposed to the bottom surface 54a.

In the above-described configuration in that the bottom surface 54a and the ceiling surface 54b of the insertion hole 54 are in contact with the cold cathode tube 17 on a line perpendicular to the bottom plate 14a of the chassis 14, a space or any component is not provided between the insertion hole 54 and the cold cathode tube 17 in the height direction of the lamp connector 19. Therefore, according to the above-described configuration, the height of the lamp connector 19 is determined by only a total of the diameter of the insertion hole 54 (4.0 mm that is same as the diameter of the cold cathode tube 17 in this embodiment) and the thickness of the bottom plate 51a and the top plate 51b (each of which is 1.0 mm in this embodiment) that is required to ensure the strength of the main body 51. As a result, the height of the lamp connector 19 can be reduced to a smallest possible height. This enables thickness reduction of the backlight device 12.

Each of the bottom surface 54a and the ceiling surface 54b of the insertion hole 54 is a flat surface extending from the insertion opening 54h to the end-side portion of the insertion hole 54.

According to such a configuration, each of the bottom surface 54a and the ceiling surface 54b having a flat surface is in contact with an outer peripheral surface of the cold cathode tube 17 having a circular cross section with point contact. The contact area between the cold cathode tube 17 and the surface of the insertion hole 54 is relatively small.

If the insertion hole is formed such that the vertical cross section of the lamp connector perpendicular to the axial line of the insertion hole includes a circular hole section such that a surface of the insertion hole is closely surround the entire outer peripheral surface of the cold cathode tube, the contact area between the cold cathode tube and the surface of the insertion hole is large. If the cold cathode tubes are lit in such a condition, a large amount of heat is radiated from the cold cathode tubes having high temperature to the lamp connectors and the temperature of the end of the cold cathode tube is lowered. Accordingly, mercury enclosed in the cold cathode tube moves to the ends where the temperature is relatively low in the cold cathode tube according to the temperature-dependent characteristics of mercury. This causes a nonuniform concentration distribution of mercury vapor wherein the concentration of mercury vapor is high at the ends of the cold cathode tube and low at the center. As a result, since the concentration of mercury vapor is comparatively low at the center of the cold cathode tube in its longitudinal direction, the light emission amount is reduced there. This may cause nonuniformity of light emission amount from the cold cathode tubes.

However, in the present embodiment, the bottom surface 54a and the ceiling surface 54b each of which is in contact with the cold cathode tube 17 is a flat surface. Therefore, the outer peripheral surface of the cold cathode tube 17 is in contact with the flat surfaces (the bottom surface 54a and the ceiling surface 54b) with point contact. This reduces the contact area between the cold cathode tube 17 and the surface of the insertion hole 54. Accordingly, the radiation amount from the cold cathode tube 17 to the lamp connector 19 is reduced and the temperature distribution in the cold cathode tube 17 is maintained to be uniform. This suppresses the nonuniform concentration of mercury vapor in the cold cathode tubes 17 and this also suppresses nonuniform light emission from the cold cathode tubes 17 and nonuniform brightness in the backlight device 12 provided with the cold cathode tubes.

In the present embodiment, the insertion hole 54 is formed such that a vertical cross section of the lamp connector 19 perpendicular to the axial line of the insertion hole includes a polygonal hole section.

By forming the insertion hole 54 such that the vertical cross section of the lamp connector 19 perpendicular to the axial line of the insertion hole 54 includes a polygonal hole section, that is, a part of the insertion hole 54 is defined by the bottom surface 54a, the ceiling surface 54a, and the side surfaces 54c, 54d that are flat surfaces, the flat surfaces forming the polygonal hole section is in contact with the outer peripheral surface of the cold cathode tube 17 with point contact. This reduces the contact area between the lamp connector 19 and the cold cathode tube 17. The vertical cross section of the lamp connector 19 perpendicular to the axial line of the insertion hole 54 includes the polygonal hole section, and this simple configuration simplifies a manufacturing process of the lamp connector 19 and reduces cost.

Especially in this embodiment, the insertion hole 54 is formed such that a vertical cross section of the lamp connector 19 perpendicular to the axial line of the insertion hole 54 includes a square hole section.

Since the length of one side of the square hole section of the lamp connector is equal to the diameter of the cold cathode tube 17, the cold cathode tube 17 is in contact with each of the bottom surface 54a, the ceiling surface 54b and the side surfaces 54c, 54d with point contact. As a result, the contact area between the cold cathode tube 17 and the surface of the insertion hole 54 is reduced, and the cold cathode tube 17 is supported at four points in the insertion hole 54 and this ensures its stability. In this embodiment, the insertion hole 54 is formed such that the vertical cross section of the lamp connector 19 perpendicular to the axial line of the insertion hole 54 includes the square hole section. However, the insertion hole may be selectively formed such that a vertical cross section of the lamp connector 19 includes a hole section in a different quadrangular shape, such as a rectangle, with considering relation between the support stability of the cold cathode tube 17 by the insertion hole 54 and the contact area between the cold cathode tube 17 and the surface of the insertion hole 54, working cost or workability of insertion of the cold cathode tube 17 into the insertion hole 54.

In this embodiment, in the main body 51 of the lamp connector 19, each of the outer surface of the bottom plate 51a opposed to the bottom plate 14a of the chassis 14 and the outer surface of the top plate 51b located on the opposite side from the bottom plate 51a is a flat surface that is substantially parallel to the bottom plate 14a.

To achieve the thickness reduction of the backlight device 12 according to the present embodiment, it is desirable to make the lamp connector to be thinner. In the main body 51 of the lamp connector 19, each of the outer surface of the bottom plate 51a (the surface opposed to the bottom plate 14a of the chassis 14) and the outer surface of the top panel 51b (the upper surface of the main body 51) is configured to be a flat surface that is substantially parallel to the bottom plate 14a of the chassis 14. Thus, no projected portion is provided on the outer surfaces of the bottom plate 51a and the top plate 51b and the outer surfaces are not inclined with respect to the bottom plate 14a. Accordingly, the height of the main body 51 from the bottom plate 51a to the top plate 51b, that is, the height of the lamp connector 19 from the bottom plate 14a of the chassis 14 is reduced to a smallest possible height.

In the present embodiment, the main body 51 is formed of nonconductive rubber, that is an elastic member.

The main body 51 is formed of a material that is elastically deformable. Therefore, at the insertion timing of the cold cathode tube 17 into the insertion hole 54 formed in the main body 51, if the end of the cold cathode tube 17 is in contact with the main body 51, the main body 51 is elastically deformed to ease the stress caused in the cold cathode tube 17. This prevents the cold cathode tube 17 from being damaged at the time of insertion of the cold cathode tube 17.

### Second Embodiment

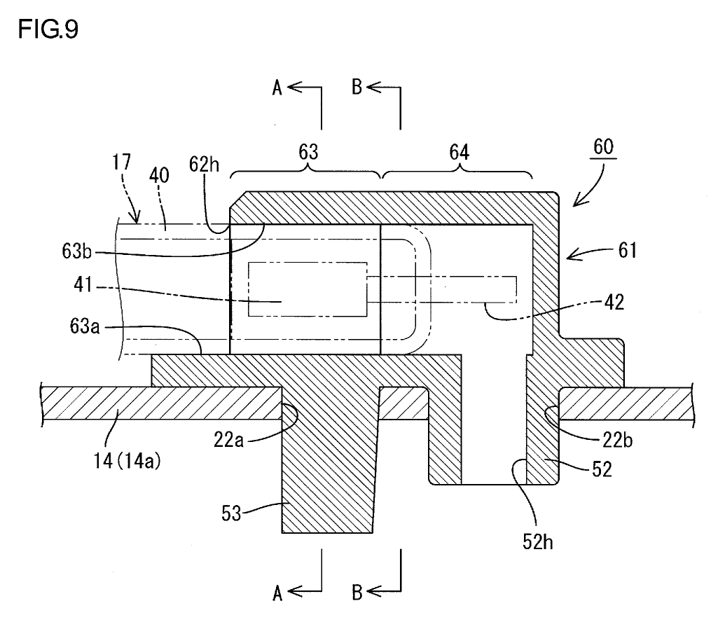

Next, a second embodiment of the present invention will be explained with reference to FIGS. 9 to 11. In the second embodiment, the configuration of the insertion hole of the lamp connector is modified and other configurations are same as the above embodiment. The same parts as the above embodiment are indicated by the same symbols and the explanation thereof is omitted.

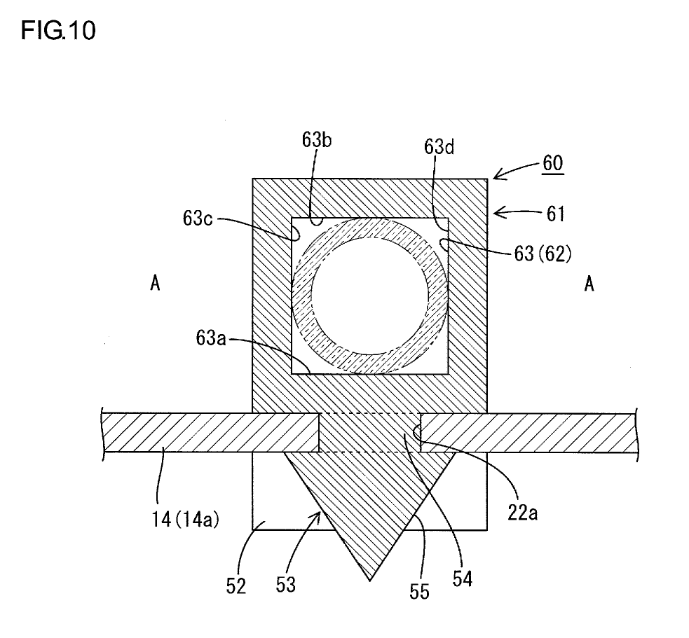

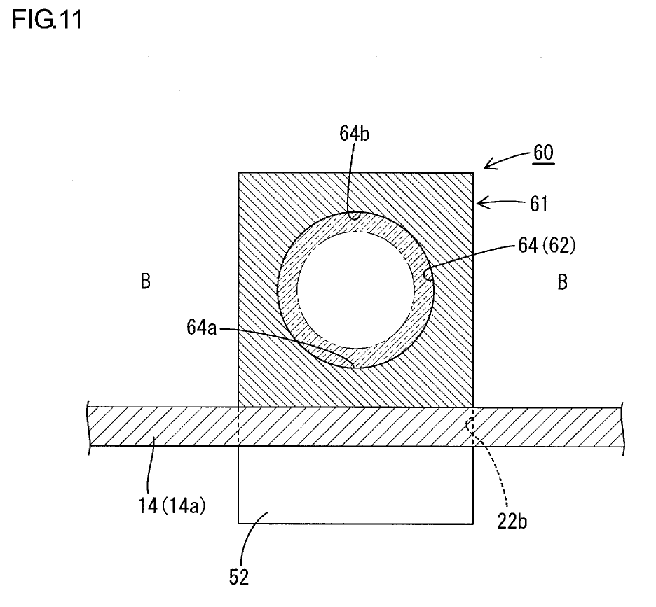

FIG. 9 is a cross-sectional view illustrating a general construction of a lamp connector according to the second embodiment. FIG. 10 is a cross-sectional view illustrating the lamp connector taken along an A-A line in FIG. 9. FIG. 11 is a cross-sectional view illustrating the lamp connector taken along a B-B line in FIG. 9.

A lamp connector 60 includes a main body 61, the introduction portion 52 and the stopper 53, as illustrated in FIG. 9. An overall shape of the main body 61 is a substantially quadrangular prism. The harness 32 is introduced to the introduction portion 52. The stopper 53 is engaged to the chassis 14. The main body 61 is formed in a substantially landscape quadrangular prism. The main body 61 is provided on an inner surface of the chassis 14 such that its longitudinal direction (axial direction) is aligned along a long-side direction of the chassis 14. An insertion hole 62 having an opening is formed at a center of a surface of the main body 61 closer to the cold cathode tubes 17. The end of the cold cathode tube 17 is inserted in the insertion hole 62 to connect the cold cathode tube 17 and the lamp connector 19.

The insertion hole 62 has an insertion opening 62h formed in a square. A portion of the insertion hole 62 near the insertion opening 62h (an opening-side portion 63), more specifically, a portion of the insertion hole 62 from the insertion opening 62h to a end-side of the stopper 53 is formed in a quadrangular prism extending along the axial direction of the main body 61. A vertical cross section of the lamp connector 60 perpendicular to the axial line of the opening-side hole portion 63 (a cross section of the lamp connector 60 in the up-and-down direction) includes a square (a polygonal, a quadrangle) hole section as same as that of the insertion opening 62h, as illustrated in FIG. 10. In other words, the opening-side portion 63 of the insertion hole 62 is defined by a flat bottom surface 63a located on the chassis 14 side, a flat ceiling surface 63b opposed to the bottom surface 63a and flat side surfaces 63c, 63d each connecting the long sides of the two surfaces. A length of each short side of the bottom surface 63a, the ceiling surface 63b, the side surfaces 63c, 63d (one side of the opening-side hole portion 63 in the vertical cross section of the lamp connector 60 perpendicular to the axial line of the opening-side hole portion 63, one side of the insertion hole 62h) is equal to the diameter (the outer diameter) of the cold cathode tube 17. Therefore, when the cold cathode tube 17 is inserted in the insertion hole 62, the cold cathode tube 17 comes in contact with the bottom surface 63a, the ceiling surface 63b and the side surfaces 63c, 63d in the opening-side portion 63. Each of the surfaces 63a, 63b, 63c, 63d of the opening-side portion 63 is a flat surface and the vertical cross section of the cold cathode tube 17 is a circle. Therefore, the opening-side portion 63 and the cold cathode tube 17 are in contact with each other with point contact.

A end-side portion (a end-side portion 64) of the insertion hole 62 which a end of the cold cathode tube 17 reaches, more specifically, a portion from the end-side end of the opening-side portion 63 to the most end-side portion of the insertion hole 62 is formed in a cylindrical shape extending along an axial line of the main body 61. In other words, as illustrated in FIG. 11, in the end-side portion 64 of the insertion hole 62, a bottom surface 64a located at the chassis 14 side and a ceiling surface 64b opposed to the bottom surface 64a form a part of a periphery. The vertical cross section of the lamp connector 60 perpendicular to the axial line of the end-side portion 64 (the cross section of the lamp connector 60 in the up-and-down direction) includes a circular hole section and the diameter of the circular hole section is equal to the diameter of the cold cathode tube 17. Therefore, when the cold cathode tube 17 is inserted in the insertion hole 62, an inner peripheral surface of the end-side portion 64 including the bottom surface 64a and the ceiling surface 64b comes in contact with an entire peripheral area of the cold cathode tube 17. Accordingly, the contact area between the surface of the insertion hole 62 and the cold cathode tube 17 is greatest at the end-side portion 64 and the cold cathode tube 17 is supported at every direction in the vertical cross section with respect to its axial direction.

As explained above, according to the present embodiment, the lamp connector 60 has the insertion hole 62 in which the end of the cold cathode tube 17 is inserted, and the opening-side portion 63 of the insertion hole 62 located at the insertion opening 62 side comprises the bottom surface 63a and the ceiling surface 63b each of which is in contact with the cold cathode tube 17. Each of the bottom surface 63a and the ceiling surface 63b is a flat surface.

According to such a configuration, in the opening-side portion 63 at the insertion opening 62 side of the insertion opening 62, each of the bottom surface 63a and the ceiling surface 63b is in contact with the cold cathode tube 17 with point contact. Accordingly, the contact area between the opening-side portion 63 and the cold cathode tube 17 is reduced and the nonuniform concentration of mercury vapor in the cold cathode tube 17 is effectively suppressed.

Mercury enclosed in the cold cathode tube 17 is hard to be concentrated at a basal portion of the electrode 41 arranged at the end of the cold cathode tube 17 (the portion from which the outer lead 42 is extended), that is, the end of the cold cathode tube 17 due to its configuration. In other words, movement of mercury is hard to be occurred at the end of the cold cathode tube 17 that is located in the end-side portion 64 of the insertion hole 62, and mercury is concentrated at a portion in the cold cathode tube 17 corresponding to the opening-side portion 63 of the insertion hole 62. Therefore, compared to the configuration in which the flat bottom surface and the flat ceiling surface are provided in the end-side portion 64 of the insertion hole 62, the nonuniform concentration of mercury vapor caused by the increase of the radiation amount from the cold cathode tube 17 is suppressed more effectively in the configuration in which the flat bottom surface 63a and the flat ceiling surface 63b are provided in the opening-side portion 63.

In the present embodiment, the end-side portion 64 of the insertion hole 62 where the end of the cold cathode tube 17 reaches is formed such that the vertical cross section of the lamp connector 60 perpendicular to the axial line of the end-side portion 64 includes the circular hole section having the diameter equal to the outer diameter of the cold cathode tube 17.

According to such a configuration, in the end-side portion 64 of the insertion hole 62, the inner peripheral surface of the end-side portion 64 is in contact with the entire outer peripheral area of the end of the cold cathode tube 17. Accordingly, the cold cathode tube 17 is stably supported.

As described above, mercury is hard to be concentrated at the end of the cold cathode tube 17. Therefore, even if the contact area between the end of the cold cathode tube 17 and the surface of the insertion hole 62 (the end-side portion 64) becomes large, the nonuniform concentration of mercury vapor is not occurred. Therefore, it is preferable that the end-side portion 64 of the insertion hole 62 is configured to stably support the end of the cold cathode tube 17.

### Other Embodiments

The embodiments according to the present invention have been described. The present invention is not limited to the embodiments explained in the above description with reference to the drawings. The following embodiments may be included in the technical scope of the present invention, for example.

(1) In the first embodiment, all of the bottom surface, the ceiling surface and side surfaces of the insertion hole of the lamp connector are flat surfaces. However, the effects of the present invention are obtained if the insertion hole is formed such that at least each of the bottom surface and the ceiling surface has a portion of a flat surface. The lamp connector having such a configuration is also included in the present invention.

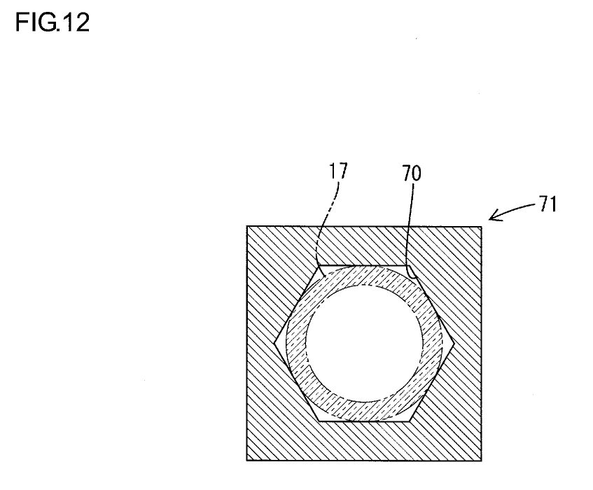

(2) In the above embodiments, the lamp connector is formed such that the vertical cross section thereof perpendicular to the axial line of the insertion hole includes a quadrangle (square) hole section. However, the insertion hole is not limited to such a shape. An insertion hole may be formed such as in a lamp connector having a different polygonal hole section, for example, a lamp connector 71 having a hexagonal insertion hole 70 illustrated in FIG. 12.

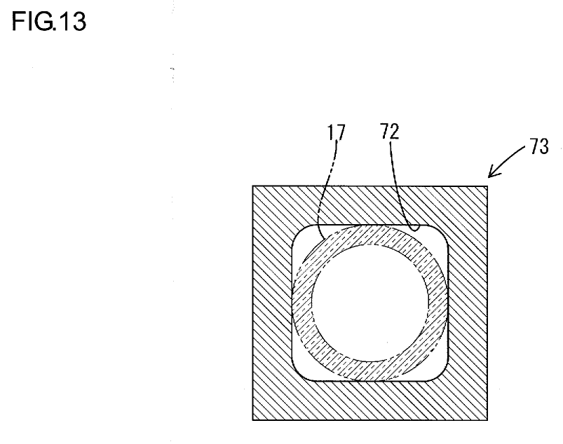

(3) In the above embodiments, the lamp connector is formed such that the vertical cross section perpendicular to the axial line of the insertion hole includes a quadrangle hole section having four corners each having a right angle. However, as illustrated in FIG. 13, a lamp connector 73 may have an insertion hole 72 having four corners each having a curved portion.

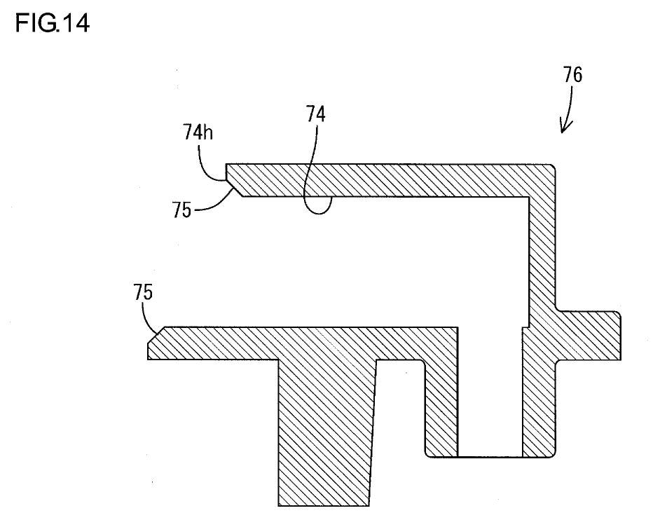

(4) In the above embodiments, the lamp connector is formed so as to have a quadrangular deep insertion hole having a constant height. However, as illustrated in FIG. 14, a lamp connector 76 may have an insertion hole 74 having an insertion opening 74h provided with tapered surfaces 75.

(5) In the above embodiments, the lamp connector is formed such that the cross section includes a circle hole section corresponding to the insertion hole and having a diameter equal to the outer diameter of the cold cathode tube. However, the diameter of the insertion hole may be smaller than the outer diameter of the cold cathode tube. In such a case, when the cold cathode tube is inserted in the insertion hole, the walls of the lamp connector are elastically deformed such that the insertion hole is expanded to have the diameter equal to the outer diameter of the cold cathode tube and this allows the insertion of the cold cathode tube.

(6) In the above embodiments, the cold cathode tubes 17 are used as the tubular lamps; however, other types of tubular lamps including hot cathode tubes can be used.

1. A lamp mount for mounting a tubular lamp having a curved outer surface to a mounting member, the lamp mount comprising:
a main body having an insertion hole for receiving an end of the tubular lamp, wherein:
the insertion hole has a bottom surface located closer to the mounting member and a ceiling surface opposed to the bottom surface; and
each of the bottom surface and the ceiling surface is to be in contact with the tubular lamp on a line perpendicular to a surface of the mounting member on which the lamp mount is to be mounted and has at least a flat surface portion.

2. The lamp mount according to claim 1, wherein the flat surface portion of each of the bottom surface and the ceiling surface is formed at least near an opening of the insertion hole, the opening through which the tubular lamp is inserted.

3. The lamp mount according to claim 1, wherein the insertion hole is formed such that a vertical cross section of the lamp mount perpendicular to an axial line of the insertion hole includes a polygonal hole section.

4. The lamp mount according to claim 1, wherein the insertion hole is formed such that a vertical cross section of the lamp mount perpendicular to an axial line of the insertion hole includes a quadrangular hole section.

5. The lamp mount according to claim 1, wherein the insertion hole is formed such that a vertical cross section of a portion of the lamp mount perpendicular to an axial line of the insertion hole includes a circular hole section having a diameter equal to an outer diameter of the tubular lamp, the portion being located near an end of the insertion hole where an end of the tubular lamp reaches.

6. The lamp mount according to claim 1, wherein:
the main body has a bottom portion opposed to the mounting member and a top portion provided at an opposite side from the bottom portion;
each of the bottom portion and the top portion of the main body has a flat surface that is substantially parallel to a mounting surface of the mounting member.

7. The lamp mount according to claim 6, wherein the main body is formed of an elastic material.

8. A lighting device comprising:
the lamp mount according to claim 1;
a mounting member to which the lamp mount is mounted; and
a tubular lamp accommodated in the mounting member and an end of which is supported by the lamp mount.

9. A display device comprising:
the lighting device according to claim 8; and
a display panel configured to provide display using light from the lighting device.

10. The display device according to claim 9, wherein the display panel is a liquid crystal display using liquid crystal.

11. A television receiver comprising the display device according to claim 9.
